(19) United States
(12) Patent Application Publication
(10) Pub. No.: US 2012/0053291 A1
(43) Pub. Date: Mar. 1, 2012

(54) POLYESTER AND LOW MOLECULAR WEIGHT POLYTRIMETHYLENE ETHER DIOL BASED COATING COMPOSITION

(75) Inventors: RAJESH GOPALAN SALIYA, Media, PA (US); Ayumu Yokoyama, Wallingford, PA (US); Hari Babu Sunkara, Hockessin, DE (US)

(73) Assignee: E. I. DU PONT DE NEMOURS AND COMPANY, Wilmington, DE (US)

(21) Appl. No.: 13/047,063

(22) Filed: Mar. 14, 2011

Related U.S. Application Data
(60) Provisional application No. 61/378,658, filed on Aug. 31, 2010.

(51) Int. Cl. B05D 3/10; C09D 167/04; C09D 167/00

(52) U.S. Cl. 524/590; 427/385.5; 524/599; 524/601; 524/606

(57) ABSTRACT

The present disclosure is directed to a coating composition having polyester and low molecular weight polytrimethylene ether glycol. This invention is further directed to a coating composition comprising components derived from renewable resources.

### FIELD OF DISCLOSURE

The present disclosure is directed to a coating composition comprising polyester and components derived from renewable resources.

### BACKGROUND OF DISCLOSURE

A typical coating finish over a substrate comprises some or all of the following layers: (1) one or more primer layers that provide adhesion and basic protection, such as corrosion protection; (2) one or more colored layers, typically pigmented, that provide most of the protection, durability and color; and (3) one or more clearcoat layers that provide additional durability and improved appearance. A colored topcoat layer can be used in place of the colored layer and clearcoat layer. A suitable primer, primer surfacer or primer filler, collectively referred to as “primer” herein, can be applied over the substrate to form the primer layer.

There are continued needs for new coating materials.

### STATEMENT OF DISCLOSURE

This invention is directed to a coating composition comprising a film forming binder, said binder consists essentially of:
A) a polyester having one or more hydroxyl crosslinkable functional groups;
B) a polytrimethylene ether glycol having a Mn (number average molecular weight) in a range of from 134 to 490; and
C) a crosslinking component consisting essentially of at least one crosslinking agent having one or more crosslinking functional groups.

This invention is also directed to a process for coating a substrate, said process comprising the steps of:
(A) applying the coating composition of this disclosure over said substrate to form a wet coating layer; and
(B) curing said wet coating layer to form a coating on said substrate.

### DETAILED DESCRIPTION

The features and advantages of the present disclosure will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “(meth)acrylate” means methacrylate or acrylate.

The term “two-pack coating composition”, also known as 2K coating composition, refers to a coating composition having two packages that are stored in separate containers and sealed to increase the shelf life of the coating composition during storage. The two packages are mixed just prior to use to form a pot mix, which has a limited pot life, typically ranging from a few minutes (15 minutes to 45 minutes) to a few hours (4 hours to 8 hours). The pot mix is then applied as a layer of a desired thickness on a substrate surface, such as an automobile body. After application, the layer dries and cures at ambient or at elevated temperatures to form a coating on the substrate surface having desired coating properties, such as, high gloss, mar-resistance and resistance to environmental etching.

The term “one-pack coating composition”, also known as 1K coating composition, refers to a coating composition having one package that is stored in one container and sealed to increase the shelf life of the coating composition during storage. The 1K coating composition can be formulated to be cured at certain curing conditions. Examples of such curing conditions can include: radiation, such as UV radiation including UV-A, UV-B, and UV-C radiations, electron beam (e-beam) radiation, infrared (IR) radiation, or lights in visible or invisible wavelengths; moisture, such as water accessible to the coating composition; heat energy, such as high temperatures; or other chemical or physical conditions.

The term “crosslinkable component” refers to a component having “crosslinkable functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with crosslinking functional groups (during the curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking functional groups. A workable combination of crosslinkable functional groups refers to the combinations of crosslinkable functional groups that can be used in coating applications excluding those combinations that would self-crosslink.

Typical crosslinkable functional groups can include hydroxyl, thiol, isocyanate, thioisocyanate, acid or polyacid, acetoacetoxy, carboxyl, primary amine, secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable functional groups.

The term “crosslinking component” refers to a component having “crosslinking functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking functional group combinations would be excluded, since, if present, these combinations would crosslink among themselves (self-crosslink), thereby destroying their ability to crosslink with the crosslinkable functional groups. A workable combination of crosslinking functional groups refers to the combinations of crosslinking functional groups that can be used in coating applications excluding those combinations that would self-crosslink. One of ordinary skill in the art would recognize that certain combinations of crosslinking functional group and crosslinkable functional groups would be excluded, since they would fail to crosslink and produce the film forming crosslinked structures. The crosslinking component can comprise one or more crosslinking agents that have the crosslinking functional groups.

Typical crosslinking functional groups can include hydroxyl, thiol, isocyanate, thioisocyanate, acid or polyacid, acetoacetoxy, carboxyl, primary amine, secondary amine, epoxy, anhydride, ketimine, aldimine, orthoester, orthocarbonate, cyclic amide or a workable combination thereof.

The term “vehicle”, “automotive”, “automobile”, “automotive vehicle”, or “automobile vehicle” refers to an automobile such as car, van, mini van, bus,

SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport that are coated with coating compositions.

The coating composition of this invention comprises a film forming binder, herein referred to as the binder. Said binder can comprise:
A) a polyester having one or more hydroxyl crosslinkable functional groups;
B) a polytrimethylene ether glycol having a Mn (number average molecular weight) in a range of from 134 to 490; and
C) a crosslinking component consisting essentially of at least one crosslinking agent having one or more crosslinking functional groups.

In one example, the binder of the coating composition of this invention, besides solvents, can consist essentially of:
A) a polyester having one or more hydroxyl crosslinkable functional groups;
B) a polytrimethylene ether glycol having a Mn (number average molecular weight) in a range of from 134 to 490; and
C) a crosslinking component consisting essentially of at least one crosslinking agent having one or more crosslinking functional groups.

In another example, the binder of the coating composition of this invention, besides solvents, can consist essentially of:
A) a polyester having one or more hydroxyl crosslinkable functional groups and having a glass transition temperature (Tg) in a range of from −75° C. to 5° C.;
B) a polytrimethylene ether glycol having a Mn (number average molecular weight) in a range of from 134 to 490; and
C) a crosslinking component consisting essentially of at least one crosslinking agent having one or more crosslinking functional groups.

The binder can contain: (a) in a range of from 20% to 80% by weight in one example, 20% to 70% by weight in another example, of the polyester; (b) in a range of from 1% to 50% by weight in one example, 1% to 30% by weight in another example, of the polytrimethylene ether glycol and (c) in a range of from 10% to 50% by weight in one example and 10% to 45% by weight in another example of the crosslinking agent. All weight percentages are based on the total weight of the binder composition. In one embodiment, the coating composition of this invention has a molar ratio of NCO:OH in a range of from 0.8:1.0 to 1.5:1.0. In another embodiment, the molar ratio of NCO:OH can be in a range of from 0.9:1.0 to 1.1:1.0.

The polyester suitable for the coating composition of this invention can be hydroxyl containing polyesters having hydroxyl crosslinkable functional groups. Typical polyesters that can be used for this invention can have an acid value of 15 to 60 and have a weight average molecular weight (Mw) from 1,000 to 50,000. The polyesters may be saturated or unsaturated and optionally, chemically modified. These polyesters are the esterification product of one or more polyhydric alcohols, such as, alkylene diols and glycols; and acids, such as monocarboxylic acids and polycarboxylic acids or anhydrides thereof, such as, dicarboxylic and/or tricarboxylic acids or tricarboxylic acid anhydrides. The polyester can be a linear polyester or a branched polyester.

The polyesters that are suitable for this invention can have a Tg (glass transition temperature) in a range of from −75° C. to 50° C., with one example in the range of from −75° C. to 40° C., another example in the range of from −75° C. to 30° C., yet another example in the range of from −75° C. to 10° C., yet another example in the range of from −75° C. to 5° C.

Examples of polyhydric alcohols that can be used to form the polyester can include triols and tetraols, such as, trimethylol propane, triethylol propane, trimethylol ethane, glycerine, and dihydric alcohols and diols that include ethylene glycol, propylene glycol, 1,3-propanediol, 1,3-butanediol, 1,4-butanediol, 1,5-pentanediol, 1,6-hexanediol, 2,2-dimethyl-1,3-propanediol, diethylene glycol, dipropylene glycol, 1,4-cyclohexane dimethanol, hydrogenated bisphenols A and F, Esterdiol 204 (Trademark of Union Carbide) and highly functional polyols, such as, trimethylolethane, trimethylolpropane, and pentaerythritol. Polyhydric alcohols having carboxyl groups may be used, such as, dimethylol propionic acid (DMPA).

Typical acids and anhydrides that can be used to form the polyester can include aliphatic or aromatic carboxylic acids and anhydrides thereof, such as, adipic acid, azelaic acid, sebacic acid, dimerized fatty acids, maleic acid, maleic anhydride, succinic acid, succinic anhydride, isophthalic acid, terephthalic acid, phthalic acid, phthalic anhydride, dimethyl terephthalic acid, naphthalene dicarboxylic acid, tetrahydro- and hexahydrophthalic anhydride, tetrachlorophthalic acid, terephthalic acid bisglycol ester, benzophenone dicarboxylic acid, trimellitic acid and trimellitic anhydride.

One example of a polyester suitable for this invention can be the esterification product of neopentyl glycol, trimethylol propane, 1,6 hexane diol, adipic acid, isophthalic acid and trimellitic anhydride.

The polyester can be a highly branched copolyester. The highly branched copolyester can have a weight average molecular weight in a range of from 1,000 to 50,000, with one example in the range of 1,000-40,000, another example in the range of 1,500-40,000, yet another example in the range of 1,500 to 30,000, and yet another example in the range of 2,000 to 30,000. The highly branched copolyester can have one or more hydroxyl crosslinkable function groups.

The highly branched copolyester can be conventionally polymerized from a monomer mixture containing a chain extender selected from the group consisting of a hydroxy carboxylic acid, a lactone of a hydroxy carboxylic acid and a combination thereof; and one or more hyper branching monomers.

One example of a highly branched polyester suitable for this invention can be synthesized by reacting dimethylol propionic acid, pentaerythritol, and caprolactone.

Conventional methods for synthesizing polyesters are known to those skilled in the art. Examples of the conventional methods can include those described in U.S. Pat. No. 5,270,362 and U.S. Pat. No. 6,998,154.

The polytrimethylene ether glycol can be prepared by an acid-catalyzed polycondensation of 1,3-propanediol (herein referred to as “PDO”), such as described in U.S. Pat. Nos. 6,977,291 and 6,720,459. The polytrimethylene ether glycol can also be prepared by a ring opening polymerization of a cyclic ether, oxetane, such as described in J. Polymer Sci., Polymer Chemistry Ed. 23, 429 to 444 (1985). The polycondensation of 1,3-propanediol is preferred over the use of oxetane since the diol is a less hazardous, stable, low cost, commercially available material and can be prepared by use of petro chemical feed-stocks or renewable resources.

A bio-route via fermentation of a renewable resource can be used to obtain the 1,3-propanediol (PDO). One example of renewable resources is corn since it is readily available and has a high rate of conversion to 1,3-propanediol and can be genetically modified to improve yields to the 1,3-propanediol. Examples of typical bio-route can include those described in U.S. Pat. No. 5, 686,276, U.S. Pat. No. 5,633,362 and U.S. Pat. No. 5,821,092. The 1,3-propanediol obtained from the renewable source and the coating compositions therefrom can be distinguished from their petrochemical derived counterparts on the basis of radiocarbon dating such as fraction of modern carbon (f_{M}), also know as ¹⁴C (f_{M}) and dual carbon-isotopic fingerprinting ¹³C/¹²C such as the one known as δ¹³C. The fraction of modern carbon f_{M} is defined by National Institute of Standards and Technology (NIST) Standard Reference Materials (RFMs) 4990B and 4990C.

The polytrimethylene ether glycol can have a Mn in a range of from 120 to 650. In one example, the polytrimethylene ether glycol can have a Mn in a range of from 120 to 490. In another example, the polytrimethylene ether glycol can have a Mn in a range of from 200 to 400. In yet another example, the polytrimethylene ether glycol can have a Mn in a range of from 250 to 490. The polytrimethylene ether glycol suitable for this disclosure need to be within the aforementioned range of Mn that can be controlled by polymerization process to have polymers with desired range of Mn, fractionation of polymers to obtain polymers having desired range of Mn, or a combination thereof. The polymerization can be controlled, for example by polymerization timing, reaction temperature, reaction pressure, or a combination thereof, to produce polymers having Mn within the aforementioned Mn range. The polytrimethylene ether glycol can be fractionated or unfractionated. In one example, the fractionated polytrimethylene ether glycol can have PDO monomers, dimers, trimer, tetramers, and pentamers. In another example, the fractionated polytrimethylene ether glycol can have dimers, trimer, tetramers, and pentamers. In yet another example, the fractionated polytrimethylene ether glycol can have trimer, tetramers, pentamers and heamers. In further example, the fractionated polytrimethylene ether glycol can have tetramers, pentamers, heamers and heptamers. In one example, the unfractionated polytrimethylene ether glycol can have, such as, PDO monomers, dimers, trimers, tetramers, pentamers, heamers and heptamers.

The polytrimethylene ether glycol can include copolymers of polytrimethylene ether glycol that can also be suitable for the coating composition of this disclosure. Examples of such suitable copolymers of polytrimethylene ether glycol can be prepared by copolymerizing 1,3-propanediol with another diol, such as, ethane diol, hexane diol, 2-methyl-1,3-propanediol, 2,2-dimethyl-1,3-propanediol, trimethylol propane and pentaerythritol. In one example, the copolymers of polytrimethylene ether glycol can be polymerized from monomers have 1,3-propanediol in a range of from 50% to 99%. In another example, the copolymers of polytrimethylene ether glycol can be polymerized from monomers have 1,3-propanediol in a range of from 60% to 99%. In yet another example, the copolymers of polytrimethylene ether glycol can be polymerized from monomers have 1,3-propanediol in a range of from 70% to 99%.

One example of copolymers of poytrimethylene ether glycol can be poly(trimethylene-ethylene ether) glycol such as disclosed in US2004/0030095A1. The poly(trimethylene-co-ethylene ether) glycols can be prepared by acid catalyzed polycondensation of in a range of from 50 to 99 mole % (preferably in a range of from 60 to 98 mole %, and more preferably in a range of from 70 to 98 mole %) 1,3-propanediol and in a range of from 50 to 1 mole % (preferably in a range of from 40 to 2 mole %, and more preferably in a range of from 30 to 2 mole %) ethylene glycol.

The polytrimethylene ether glycol can have in a range of from 10% to 100% of dimers, percentage based on the total weight of the polytrimethylene ether glycol. The polytrimethylene ether glycol can have in a range of from 20% to 100% of dimers in an example, in a range of from 30% to 100% of dimers in another example, in a range of from 40% to 100% of dimers in another example, and in a range of from 50% to 100% of dimers in a yet further example, all percentage based on the total weight of the polytrimethylene ether glycol.

The polytrimethylene ether glycol useful in the compositions and methods disclosed herein can contain small amounts of other repeat units, for example, from aliphatic or aromatic diacids or diesters, such as disclosed in U.S. Pat. No. 6,608,168. This type of trimethylene ether glycol oligomer can also be called a “random polytrimethylene ether ester”, and can be prepared by polycondensation of 1,3-propanediol reactant and about 10 to about 0.1 mole % of aliphatic or aromatic diacid or esters thereof, such as terephthalic acid, isophthalic acid, bibenzoic acid, naphthalic acid, bis(p-carboxyphenyl) methane, 1,5-naphthalene dicarboxylic acid, 2,6-naphthalene dicarboxylic acid, 2,7-naphthalene dicarboxylic acid, 4,4′-sulfonyl dibenzoic acid, p-(hydroxyethoxy)benzoic acid, and combinations thereof, and dimethyl terephthalate, bibenzoate, isophthlate, naphthalate and phthalate; and combinations thereof. Of these, terephthalic acid, dimethyl terephthalate and dimethyl isophthalate are preferred.

The polytrimethylene ether polymers with functional groups other than hydroxyls end groups can also be used. Examples of polytrimethylene ether glycol oligomers with amine and ester end functional groups can include those disclosed in U.S. Pat. No. 7,728,175.

A blend of polytrimethylene ether glycol having different molecular weights can be used. Blends of the polytrimethylene ether glycol and other cycloaliphatic hydroxyl containing either branched or linear oligomers can be used. Such hydroxyl containing oligomers are known to those skilled in the art. Examples of such hydroxyl containing oligomers can include those disclosed by Barsotti, et al. in U.S. Pat. No. 6,221,494.

The one or more crosslinking functional groups can comprise isocyanate group. The crosslinking agent can be selected from aliphatic polyisocyanates, cycloaliphatic polyisocyanates, aromatic polyisocyanates, trifunctional isocyanates, isocyanate adducts, or a combination thereof. The crosslinking agent can also be selected from isophorone diisocyanate, toluene diisocyanate, hexamethylene diisocyanate, diphenylmethane diisocyanate, triphenyl triisocyanate, benzene triisocyanate, toluene triisocyanate, the trimer of hexamethylene diisocyanate, or a combination thereof.

Further examples of suitable aliphatic, cycloaliphatic and aromatic polyisocyanates can include: 2,4-toluene diisocyanate, 2,6-toluene diisocyanate (“TDI”), 4,4-diphenylmethane diisocyanate (“MDI”), 4,4′-dicyclohexyl methane diisocyanate (“H12MDI”), 3,3′-dimethyl-4,4′-biphenyl diisocyanate (“TODI”), 1,4-benzene diisocyanate, trans-cyclohexane-1,4-diisocyanate, 1,5-naphthalene diisocyanate (“NDI”), 1,6-hexamethylene diisocyanate (“HDI”), 4,6-xylene diisocyanate, isophorone diisocyanate,(“IPDI”), other aliphatic or cycloaliphatic di-, tri- or tetra-isocyanates, such as, 1,2-propylene diisocyanate, tetramethylene diisocyanate, 2,3-butylene diisocyanate, octamethylene diisocyanate, 2,2,4-trimethyl hexamethylene diisocyanate, dodecamethylene diisocyanate, omega-dipropyl ether diisocyanate, 1,3-cyclopentane diisocyanate, 1,2-cyclohexane diisocyanate, 1,4-cyclohexane diisocyanate, 4-methyl-1,3-diisocyanatocyclohexane, dicyclohexylmethane-4,4′-diisocyanate, 3,3′-dimethyl-dicyclohexylmethane 4,4′-diisocyanate, polyisocyanates having isocyanurate structural units, such as, the isocyanurate of hexamethylene diisocyanate and the isocyanurate of isophorone diisocyanate, the adduct of 2 molecules of a diisocyanate, such as, hexamethylene diisocyanate, uretidiones of hexamethylene diisocyanate, uretidiones of isophorone diisocyanate and a diol, such as, ethylene glycol, the adduct of 3 molecules of hexamethylene diisocyanate and 1 molecule of water, allophanates, trimers and biurets, for example, of hexamethylene diisocyanate, allophanates, trimers and biurets, for example, of isophorone diisocyanate and the isocyanurate of hexane diisocyanate. MDI, HDI, TDI and isophorone diisocyanate are preferred because of their commercial availability.

Tri-functional isocyanates also can be used, such as, triphenyl methane triisocyanate, 1,3,5-benzene triisocyanate, 2,4,6-toluene triisocyanate. Trimers of diisocyanates, such as, the trimer of hexamethylene diisocyanate, sold as Tolonate® HDT from Rhodia Corporation under the registered trademark and the trimer of isophorone diisocyanate can also be suitable.

Other suitable crosslinking components can include melamine formaldehyde, benzoguanamine formaldehyde, and urea formaldehyde.

A silane crosslinking component also can be suitable. One example of silane crosslinking component can be an aminofunctional silane crosslinking agent. Examples of suitable aminofunctional silanes can include aminomethyltriethoxysilane, gamma-aminopropyltrimethoxysilane, gamma-aminopropyltriethoxysilane, gamma-aminopropylmethyldiethoxysilane, gamma-aminopropylethyldiethoxysilane, gamma-aminopropylphenyldiethoxyysilane, N-beta(aminoethyl)gamma-aminopropyltrimethoxysilane, delta-aminobutyltriethoxysilane, delta-aminobutylethyldiethoxysilane and diethylene triamino propylaminotrimethoxysilane. Preferred are N-beta(aminoethyl)gamma-aminopropyltrimethoxysilane commercially sold as Silquest® A 1120 and diethylene triamino propylaminotrimethoxysilane that is commercially sold as Silquest® A 1130. Both of theses silanes are sold by OSi Specialties, Inc. Danbury, Conn., under respective registered trademarks.

When an amino silane crosslinking agent is used, additional amino functional curing agents, such as, primary, secondary and tertiary amines, that are well known in the art can be added. Typically, aliphatic amines containing a primary amine group, such as, diethylene triamine, and triethylene tetramine can be added. Tertiary amines, such as, tris-(dimethyl aminomethyl)-phenol can also be used.

The coating composition can further comprise one or more pigments. Any pigments suitable for coating can be used. Conventional inorganic and organic colored pigments, metallic flakes and powders, such as, aluminum flake and aluminum powders; special effects pigments, such as, coated mica flakes, coated aluminum flakes colored pigments, a combination thereof can be used. Transparent pigments or pigments having the same refractive index as the cured binder can also be used.

The coating composition can further comprise one or more solvents, ultraviolet light stabilizers, ultraviolet light absorbers, antioxidants, hindered amine light stabilizers, leveling agents, rheological agents, thickeners, antifoaming agents, wetting agents, catalysts, or a combination thereof. Any additives suitable for coating can be used.

Typical catalysts can include dibutyl tin dilaurate, dibutyl tin diacetate, dibutyl tin dichloride, dibutyl tin dibromide, triphenyl boron, tetraisopropyl titanate, triethanolamine titanate chelate, dibutyl tin dioxide, dibutyl tin dioctoate, tin octoate, aluminum titanate, aluminum chelates, zirconium chelate, hydrocarbon phosphonium halides, such as, ethyl triphenyl phosphonium iodide and other such phosphonium salts, and other catalysts or mixtures thereof known to those skilled in the art.

Typically, the coating composition can comprise up to 95% by weight, based on the weight of the coating composition, of one or more solvents. The coating composition of this disclosure can have a solid content in a range of from 20% to 80% by weight in one example, in a range of from 50% to 80% by weight in another example and in a range of from 60% to 80% by weight in yet another example, all based on the total weight of the coating composition. The coating composition of this disclosure can also be formulated at 100% solids by using a low molecular weight acrylic resin reactive diluent.

Any typical organic solvents can be used to form the coating composition of this disclosure. Examples of solvents include, but not limited to, aromatic hydrocarbons, such as, toluene, xylene; ketones, such as, acetone, methyl ethyl ketone, methyl isobutyl ketone, methyl amyl ketone and diisobutyl ketone; esters, such as, ethyl acetate, n-butyl acetate, isobutyl acetate and a combination thereof.

The coating composition should comprise no more than 20% of water and can comprise 0 to 20% of water in one example, 0 to 15% of water in another example, 0 to 10% of water in yet another example, 0 to 5% of water in a further example, and 0 to 2% of water in yet another example.

The coating composition of this disclosure can also comprise one or more ultraviolet light stabilizers in the amount of 0.01% to 10% by weight, based on the weight of the coating composition. Examples of such ultraviolet light stabilizers can include ultraviolet light absorbers, screeners, quenchers, and hindered amine light stabilizers. An antioxidant can also be added to the coating composition, in the amount of about 0.01% to 5% by weight, based on the weight of the coating composition.

Typical ultraviolet light stabilizers that are suitable for this disclosure can include benzophenones, triazoles, triazines, benzoates, hindered amines and mixtures thereof. A blend of hindered amine light stabilizers, such as Tinuvin® 328 and Tinuvin®123, all commercially available from Ciba Specialty Chemicals, Tarrytown, N.Y., under respective registered trademark, can be used.

Typical ultraviolet light absorbers that are suitable for this disclosure can include hydroxyphenyl benzotriazoles and derivatives; hydroxyphenyl s-triazines and derivatives; and hydroxybenzophenone U.V. absorbers and derivatives.

Typical antioxidants that are known to or developed by those skilled in the art can be suitable. Examples of commercially available antioxidants can include hydroperoxide decomposers, such as Sanko® HCA (9,10-dihydro-9-oxa-10-phosphenanthrene-10-oxide), triphenyl phosphate and other organo- phosphorous compounds, such as, Irgafos® TNPP from Ciba Specialty Chemicals, Irgafos® 168, from Ciba Specialty Chemicals, Ultranox® 626 from GE Specialty Chemicals, Mark PEP-6 from Asahi Denka, Mark HP-10 from Asahi Denka, Irgafos® P-EPQ from Ciba Specialty Chemicals, Ethanox 398 from Albemarle, Weston 618 from GE Specialty Chemicals, Irgafos® 12 from Ciba Specialty Chemicals, Irgafos® 38 from Ciba Specialty Chemicals, Ultranox® 641 from GE Specialty Chemicals and Doverphos® S-9228 from Dover Chemicals, under respective registered trademarks.

Typical hindered amine light stabilizers can include N-(1,2,2,6,6-pentamethyl-4-piperidinyl)-2-dodecyl succinimide, N(1acetyl-2,2,6,6-5 tetramethyl-4-piperidinyl)-2-dodecyl succinimide, N-(2hydroxyethyl)-2,6,6,6-tetramethylpiperidine-4-ol-succinic acid copolymer, 1,3,5 triazine-2,4,6-triamine, N,N′″-[1,2-ethanediybis[[[4,6-bis[butyl(1,2,2,6,6-pentamethyl-4-piperidinyl) amino]-1,3,5-triazine-2-yl]imino]-3,1-propanediyl]]bis[N, N′″-dibutyl-N′,N′″-bis (1,2,2,6,6-pentamethyl-4-piperidinyl)], poly-[[6-[1,1,3,3-tetramethylbutylyamino]-1,3,5-trianzine-2,4-diyl][2,2,6,6-tetramethylpiperidinyl)-imino]-1,6-hexane-diyl[(2,2,6,6-tetramethyl-4-piperidinyl)-imino]), bis(2,2,6,6-tetramethyl-4-piperidinyl)sebacate, bis(1,2,2,6,6-pentamethyl-4-piperidinyl)sebacate, bis(1-octyloxy-2,2,6,6-tetramethyl-4-piperidinyl) sebacate, bis(1,2,2,6,6-pentamethyl-4-piperidinyl) [3,5bis(1,1-dimethylethyl-4-hydroxy-phenyl)methyl]butyl propanedioate, 8-acetyl-3-dodecyl-7,7,9,9,-tetramethyl-1,3,8-triazaspiro (4,5)decane-2,4-dione, and dodecyl/tetradecyl-3-(2,2,4,4-tetramethyl-2l-oxo-7-oxa-3,20-diazal dispiro(5.1.11.2)henicosan-20-yl) propionate.

The coating compositions of this disclosure can comprise conventional coating additives. Examples of such additives can include wetting agents, leveling and flow control agents, for example, Resiflow®S (polybutylacrylate), BYK® 320 and 325 (high molecular weight polyacrylates), BYK® 347 (polyether-modified siloxane) under respective registered tradmarks, leveling agents based on (meth)acrylic homopolymers; rheological control agents, such as highly disperse silica, fumed silica or polymeric urea compounds; thickeners, such as partially crosslinked polycarboxylic acid or polyurethanes; antifoaming agents; catalysts for the crosslinking reaction of the OH-functional binders, for example, organic metal salts, such as, dibutyltin dilaurate, zinc naphthenate and compounds containing tertiary amino groups, such as, triethylamine, for the crosslinking reaction with polyisocyanates. The additives are used in conventional amounts familiar to those skilled in the art.

The coating compositions according to the disclosure can further contain reactive low molecular weight compounds as reactive diluents that are capable of reacting with the crosslinking agent. For example, low molecular weight polyhydroxyl compounds, such as, ethylene glycol, propylene glycol, trimethylolpropane and 1,6-dihydroxyhexane can be used.

Depending upon the type of crosslinking agent, the coating composition of this invention can be formulated as one-pack (1K) or two-pack (2K) coating composition. If polyisocyanates with free isocyanate groups are used as the crosslinking agent, the coating composition can be formulated as a two-pack coating composition in that the crosslinking agent is mixed with other components of the coating composition only shortly before coating application. If blocked polyisocyanates are, for example, used as the crosslinking agent, the coating compositions can be formulated as a one-pack (1K) coating composition. The coating composition can be further adjusted to spray viscosity with organic solvents as determined by those skilled in the art before being applied.

In a typical two-pack coating composition comprising two packages, the two packages are mixed together shortly before application. The first package typically can contain the binder including the polyester having one or more hydroxyl crosslinkable functional groups, the polytrimethylene ether glycol and optionally, pigments. The pigments can be dispersed in the first package using conventional dispersing techniques, for example, ball milling, sand milling, and attritor grinding. The second package can contain the crosslinking agent, such as, a polyisocyanate crosslinking agent, and solvents.

The coating composition according to the disclosure can be suitable for vehicle and industrial coating and can be applied using known processes. In the context of vehicle coating, the coating composition can be used both for vehicle original equipment manufacturing (OEM) coating and for repairing or refinishing coatings of vehicles and vehicle parts. Curing of the coating composition can be accomplished at ambient temperatures, such as temperatures in a range of from 18° C. to 35° C., or at elevated temperatures, such as at temperatures in a range of from 35° C. to 150° C. Typical curing temperatures of 20° C. to 80° C., in particular of 20° C. to 60° C., can be used for vehicle repair or refinish coatings.

The coating composition can be applied by conventional techniques, such as, spraying, electrostatic spraying, dipping, brushing, and flow coating. Typically, the coating is applied to a dry film thickness of 20 to 300 microns and preferably, 50 to 200 microns, and more preferably, 50 to 130 microns.

The linear or the branched polyesters, or a combination thereof can be suitable for this invention. In one example, only linear polyesters are used in the coating composition. In another example, only the branched polyesters are used in the coating composition. In yet another example, both the linear and the branched polyesters are used in the coating composition. Typically, the coatings comprising the branched polyesters can have lower viscosity, shorter dry-to-touch time and better early hardness comparing to the coatings comprising the linear polyesters. The shorter dry-to-touch time and higher early hardness are typically useful for increasing productivity in coating applications since the substrates being coated can be moved to next coating process in a shorter time.

### Examples

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Procedure 1: Preparation of Polytrimethylene Ether Glycol Having Number Average Molecular Weight 250

Twelve kilogram (kg) renewably sourced 1,3-propanediol (PDO) monomers commercially available from DuPont Tate & Lyle Bioproducts, Wilmington, Del., USA, were added to a 20 L glass reactor equipped with a condenser and an agitator. The glass reactor was purged with N₂ at the rate 3 L/min. Triflic acid (trifluoromethanesulfonic acid) was added into the reactor to a final concentration of 0.1 wt % and the mixture was heated up to 180° C. with agitation set to 200 RPM to allow the acid-catalyzed polycondensation to proceed. The reaction volatiles were condensed in the condenser and the crude polymer product was retained in the reactor. Crude polymer samples were taken periodically for color and molecular weight analysis. Once the desired Mn was achieved, the polymerization was terminated by turning the heat down. The polymer was neutralized by treating the crude polymer with XUS ion exchange resin, available from Dow Chemical, Midland, Mich., USA, in 2 stages. In the first stage, 2 weight parts of the XUS ion exchange resin and 98 weight parts of the crude polymer were mixed at a temperature of about 105° C. for about 1 hour. In the second stage, an additional 2 weight parts of the XUS ion exchange resin was added to the crude polymer and further mixed for additional 3 hours. Neutralization was conducted under sub-surface nitrogen sparging of 5 L/min and a mixing speed of 200 RPM. The product was filtered to remove the ion exchange resin. Filtration was done at 60° C. Once the product was free of solids, it was dried by heating to about 95° C., with sub-surface nitrogen sparging of about 10 L/min and mixing speed of 150 RPM. An antioxidant, BHT (Butylated hydroxyl toluene), available from Aldrich, St. Louis, Mo., USA, was added to the crude polymer to a final concentration about 200 ppm.

### Procedure 2: Fractionation of Polytrimethylene Ether Glycol

To a 500 mL, 3-neck round bottom flask equipped with a mechanical stirrer, a distillation adapter, a condenser and a graduated distillation receiver, 367.6 g of polytrimethylene ether glycol having number average molecular weight of 250 was added. The polymer was heated with a proportional integral derivative (PID) controller connected to a heating mantle and thermocouple. The controller was set to maintain a batch temperature of 50° C. at a power setting of 50% (300 mL-2 L). The flask was fully vacuumed to less than 5 torr, then the controller was turned on, and the reaction was stirred at 200 rpm. The temperature set point and the stirring speed were increased to a maximum of 280 ° C. and 300 rpm, respectively as the distillation progressed. Several fractions were collected, approximately every 20 mL, using the distilling receiver to remove the flask containing the fraction while maintaining the vacuum on the distillation flask. The temperature controller and vacuum pump were turned off after 8 hours and the remaining material was allowed to cool overnight under a blanket of nitrogen.

TABLE 1
Fractionation of polytrimethylene ether glycol.

| | PDO | Dimer | Trimer | Tetramer | Pentamer | Heamer | Heptamer |
|---|---|---|---|---|---|---|---|
| Unfractionated | 2.7% | 15.0% | 20.0% | 22.4% | 18.6% | 15.9% | 3.8% |
| B-1 | 32.9% | 46.5% | 12.7% | 0.9% | — | — | — |
| B-2 | 16.6% | 52.0% | 21.8% | 5.0% | — | — | — |
| B-3 | 4.9% | 52.4% | 31.4% | 8.7% | 0.6% | — | — |
| B-4 | 1.7% | 43.4% | 36.4% | 15.6% | 1.1% | — | — |
| B-5 | 0.5% | 37.4% | 40.4% | 18.4% | 1.8% | — | — |
| B-6 | — | 27.9% | 44.1% | 23.4% | 3.2% | — | — |
| B-7 | — | 17.2% | 44.0% | 30.9% | 6.7% | — | — |
| B-8 | — | 9.7% | 42.8% | 36.5% | 9.7% | — | — |
| B-9 | — | 2.0% | 41.8% | 42.0% | 12.8% | — | — |
| B-10 | — | — | 30.5% | 46.0% | 19.8% | 2.3% | — |
| B-11 | — | — | 18.9% | 48.1% | 26.9% | 5.3% | — |
| B-12 | — | — | 10.6% | 49.5% | 32.3% | 7.0% | — |
| B-13 | — | — | 3.9% | 47.7% | 38.5% | 9.4% | — |
| B-14 | — | — | 0.6% | 41.6% | 45.0% | 12.2% | — |
| B-15 | — | — | — | 28.7% | 49.7% | 20.4% | 0.7% |
| B-16 | — | — | — | 17.0% | 51.4% | 27.6% | 2.0% |

The fractions were analyzed by GC-MS and concentrations of oligomers present in unfractionated and fractionated polytrimethylene ether glycol are reported in Table 1.

Calculated number average molecular weights (Mn) for the polytrimethylene ether glycol are shown in Table 2.

TABLE 2
Number average molecular weight (Mn).

| Polytrimethylene ether glycol | Calculated Mn |
|---|---|
| Dimer | 134 |
| Trimer | 192 |
| Tetramer | 250 |
| Pentamer | 308 |
| Hexamer | 366 |
| Heptamer | 424 |

### Procedure 3: Preparation of Polyesters

### (A) Preparation of Linear Polyesters:

A polyester was prepared by charging the following ingredients according to Table 3 into a reaction vessel equipped with a heating mantle, water separator, thermometer and stirrer, and under nitrogen.

TABLE 3
Reaction Ingredients (grams).

| | Weight |
|---|---|
| Portion 1 | |
| Xylene | 19.553 |
| Pentaerythritol | 93.58 |
| Benzoic acid | 167.89 |
| Portion 2. | |
| Neopentyl glycol | 296.21 |
| Isophthalic acid | 142.80 |
| Phthallic anhydride | 127.29 |
| Adipic acid | 62.78 |
| Xylene | 15.26 |
| Portion 3 | |
| Ethyl acetate | 113.51 |

Portion 1 was added to the reactor and heated to its reflux temperature, about 190° C. The reactor was heated stepwise to 215° C. and held until the acid number was 33 or less. After cooling the reactor to 80° C., Portion 2 was added and the reactor was heated to reflux, about 175° C. The temperature was then increased stepwise to 215° C. That temperature was held until an acid number between 3 and 7 at about 98 wt % solids was reached. Portion 3 was added after cooling to about 80° C. The resulting polymer had a wt% solids of about 82%, and Gardner-Holdt viscosity between Z1+½ to Z3+¼.

### (B) Preparation of Branched Polyesters:

Branched polyester was prepared by charging the following ingredients in Table 4 into a reaction vessel equipped with a heating mantle, short path distillation head with a water separator, thermometer and stirrer, and under nitrogen.

TABLE 4
Reaction Ingredients (Parts by Weight).

| | Parts by weight |
|---|---|
| Portion 1 | |
| Caprolactone | 376.04 |
| Stannous octoate | 2.83 |
| Xylene | 43.52 |
| Portion 2 | |
| Dimethylol propionic acid | 188.02 |
| Pentaerythritol | 7.62 |
| Portion 3 | |
| Methyl amyl ketone | 252.22 |

Portion 1 was added to the reactor in order with mixing and heated to about 70° C. Portion 2 was then added to the reactor and the reaction mixture was heated to its reflux temperature (170−200° C.) and the water of reaction was collected in the water separator. The reaction mixture was not allowed to exceed 200° C. and was held at temperature until an acid number less than 3 at 92.7 wt % solids was obtained. The polymer solution was thinned with Portion 3 to desired solids and viscosity. The resulting polymer had a wt% solids between 64.5 and 67.5 wt % solids and a Gardner-Holdt viscosity between N and R.

### Procedure 4: Preparation of Pigments Dispersion

A red dispersion was prepared using the following procedure. Ingredients in Table 5 were added in order to an attritor with mixing and mixed for approximately 5 minutes. The Quinacridone red pigment (Cinquasia red YRT-859-D by Ciba Specialty Chemicals) was slowly added and the mixture was mixed for another 5 minutes. The grinding media containing 1816 grams of ⅛″ steel shots were added. The mixture was milled for 5 hours at 350 rpm. The dispersion was separated from the grinding media. The pigment was well dispersed to give a uniform dispersion with a viscosity of 770 cps at 20 rpm as measured by a Brookfield viscometer.

TABLE 5
Pigments Dispersion

| Ingredient | Wt (grams) |
|---|---|
| t-butyl acetate | 72.7 |
| EFKA ®-4340 dispersant⁽¹⁾ | 35.4 |
| Magnesium montmorillonite⁽²⁾ | 2.3 |
| Linear polyester⁽³⁾ | 211.6 |
| Total | 321.8 |

⁽¹⁾Available from Ciba ® Specialty Chemicals Inc, Tarrytown, New York, USA, under respective registered trademarks.
⁽²⁾Available as Bentone ® 27 from Elementis Specialties Inc., Hightstown, New Jersey, USA, under respective registered trademarks.
⁽³⁾The linear polyester was formed from following monomers at the specified molar ratio: benzoic acid 6.4/pentaerythritol 3.2/noepentyl glycol 12.8/isophthalic acid 4.0/phthalic acid 4.0/adipic acid 2.0. The linear polyester has a weight molecular weight of Mw 1,700, and a Tg of +3° C.

### Coating Compositions

Coating compositions are prepared according to Table 6 to form individual pot mix.

TABLE 6
Coating Compositions (grams).

| | Example 1 | Example 2 | Example 3 | Example 4 |
|---|---|---|---|---|
| Linear polyester⁽¹⁾ | 50.0 | — | 50.0 | — |
| Branched polyester⁽²⁾ | — | 50.0 | — | 50.0 |
| Pigments Dispersion⁽³⁾ | 32.0 | 32.0 | 32.0 | 32.0 |
| Unfractionated | 6.5 | 6.5 | | |
| Polytrimethylene | | | | |
| ether glycol⁽⁴⁾ | | | | |
| Fractionated | — | — | 4.2 | 4.2 |
| Polytrimethylene | | | | |
| ether glycol⁽⁵⁾ | | | | |
| Isocyanates | 48.0 | 48.0 | 48.0 | 48.0 |
| crosslinking agent | | | | |
| (FG-1333)⁽⁶⁾ | | | | |
| Total | 136.5 | 136.5 | 134.2 | 134.2 |

⁽¹⁾The linear polyester was from “Procedure 3(A)”. The linear polyester has a weight molecular weight of Mw 1,700, and a Tg of +3° C.
⁽²⁾The branched polyester was from “Procedure 3(B)” with specified weight percentage (wt %): caprolactone 65.78 wt %/dimethylol propionic acid 32.89 wt %/pentaerythritol 1.33 wt %. The branched polyester has a weight molecular weight of Mw 20,000, and a Tg of −50° C.
⁽³⁾Pigments dispersion was from Procedure 4.
⁽⁴⁾Unfractionated polytrimethylene ether diols are prepared in Procedure 1 without fractionation.
⁽⁵⁾The fractionated polytrimethylene ether glycol is the B-3 fraction from Procedure 2.
⁽⁶⁾FG-1333 is a crosslinking activator comprising diisocyanates, available from E. I. DuPont de Nemours and Company, Wilmington, DE, USA.

What is claimed is:

1. A coating composition comprising a film forming binder, said binder consists essentially of:
A) a polyester having one or more hydroxyl crosslinkable functional groups;
B) a polytrimethylene ether glycol having a Mn (number average molecular weight) in a range of from 134 to 490; and
C) a crosslinking component consisting essentially of at least one crosslinking agent having one or more crosslinking functional groups.

2. The coating composition of claim 1, wherein the polytrimethylene ether glycol has a Mn in a range of from 200 to 490.

3. The coating composition of claim 1, wherein the polytrimethylene ether glycol has in a range of from 10% to 100% of dimers, percentage based on the total weight of the polytrimethylene ether glycol.

4. The coating composition of claim 1, wherein the polytrimethylene ether glycol is polymerized from bio-derived 1,3-propanediol.

5. The coating composition of claim 1, wherein said one or more crosslinkable functional groups is selected from hydroxyl groups, carboxyl groups, glycidyl groups, amino groups, silane groups, or a combination thereof.

6. The coating composition of claim 1, wherein said one or more crosslinking functional groups comprise isocyanate group.

7. The coating composition of claim 1, wherein the polyester is one or more linear polyesters, one or more branched polyesters, or a combination thereof.

8. The coating composition of claim 7, wherein said linear polyesters have a weight average molecular weight of 500 to 5,000 and are polymerized from monomers selected from the group consisting of benzoic acid, pentaerythritol, noepentyl glycol, isophthalic acid, phthalic acid, adipic acid, and a combination thereof.

9. The coating composition of claim 7, wherein said branched polyesters have a weight average molecular weight of 1,000 to 50,000 and are polymerized from monomers selected from the group consisting of caprolactone, dimethylol propionic acid, pentaerythritol, add more monomer from spec and a combination thereof.

10. The coating composition of claim 1, wherein the crosslinking agent is one or more organic polyisocyanates selected from the group consisting of aliphatic polyisocyanates, cycloaliphatic polyisocyanates, aromatic polyisocyanates, trifunctional isocyanates and isocyanate adducts.

11. The coating composition of claim 1, 2, 3, 4, 5, 6, 7, 8, 9, or 10 further comprising one or more solvents, one or more pigments, ultraviolet light stabilizers, ultraviolet light absorbers, antioxidants, hindered amine light stabilizers, leveling agents, rheological agents, thickeners, antifoaming agents, wetting agents, catalysts, or a combination thereof.

12. A substrate coated with the coating composition of claim 1, 2, 3, 4, 5, 6, 7, 8, 9, or 10.

13. A process for coating a substrate, said process comprising the steps of:
(A) applying the coating composition of claim 1 over said substrate to form a wet coating layer; and
(B) curing said wet coating layer to form a coating on said substrate.

14. A substrate coated with the process of claim 13.
